(19) United States
(12) Patent Application Publication
(10) Pub. No.: US 2008/0031679 A1
(43) Pub. Date: Feb. 7, 2008

(54) APPLICATORS

(75) Inventors: Steven MAY-RUSSELL, Abbey Park (GB); Daniel BARTRAM, Swadlincote (GB)

Correspondence Address: DAVIS BUJOLD & Daniels, P.L.L.C., 112 PLEASANT STREET, CONCORD, NH, 03301, US

(73) Assignee: SUPREME ORGANICS LIMITED, Exhall (GB)

(21) Appl. No.: 11/833,463

(22) Filed: Aug. 3, 2007

(30) Foreign Application Priority Data
Aug. 5, 2006 (GB) 0615604.6

(51) Int. Cl. B05C 11/00; A45D 26/00

(52) U.S. Cl. 401/266; 401/263

(57) ABSTRACT

An applicator has a body member, the body member being adapted at one end for connection to a container of extrudable material, the body member defining an open bore extending from said one end to an opposite end, the opposite end of the body member defining a boss formation, a cap formation slidably engaging the boss formation for movement axially thereof, between a first position and a second position, the cap formation having a cylindrical side wall and an end wall which closes the bore through the body member, the side wall defining an outlet orifice which opens to the bore through the body member laterally of axis of the bore and a formation on the body member extending longitudinally of the bore within the cap formation, for closing the outlet orifice, when the cap formation is in its first position, the outlet orifice being opened by movement of the cap formation to its second position.

This application claims priority from British Application Ser. No. 0615604.6 filed Aug. 5, 2006.

### FIELD OF INVENTION

This invention relates to applicators and in particular applicators for applying a bead or ribbon of an extrudable material to a surface. In particular the applicators are suitable for applying wax to the surface of the skin for depilatory procedures. The applicators may however be used for applying other extrudable materials, for example creams for depilatory or other purposes.

### BACKGROUND OF INVENTION

WO 96/00021 discloses a wax applicator which attaches to a wax container to which pressure may be applied, to extrude the wax through an elongate aperture defined by the applicator. Gate means are provided to close the aperture, when the applicator is not in use, to prevent leakage and contamination of the contents of the applicator/container.

The manner in which the gate is constructed requires a relatively wide aperture, which is not suitable for all applications, for example for applying wax to the eyebrows, when a narrow bead of wax must be accurately located.

### SUMMARY OF INVENTION

According to one aspect of the present invention, an applicator comprises a body member, the body member being adapted at one end for connection to a container of extrudable material, the body member defining an open bore extending from said one end to an opposite end, the opposite end of the body member defining a boss formation, a cap formation slidably engaging the boss formation for movement axially thereof, between a first position and a second position, the cap formation having a cylindrical side wall and an end wall which closes the bore through the body member, the side wall defining an outlet orifice which opens to the bore through the body member laterally of axis of the bore and a formation on the body member extending longitudinally of the bore within the cap formation, for closing the outlet orifice, when the cap formation is in its first position, the outlet orifice being opened by movement of the cap formation to its second position.

In accordance with the present invention the closure means is contained within the cap formation, which itself may be of smaller diameter that the outlet from the container. The present invention will thereby provide a compact applicator suitable for providing a thin bead of wax or similar material, where required.

According to a preferred embodiment of the invention, the end wall of the cap formation extends in a plane inclined to the plane normal to the axis of the bore, the outlet orifice being located at the apex of the cap formation. Preferably the outlet orifice is defined in a planar outer wall surface of the cap formation, which is inclined to both the end wall and the axis of the bore.

According to one embodiment, the cap formation is slidably located with respect to an internal cylindrical surface of the boss formation, a baffle formation on the body member extending longitudinally on the inside of the cylindrical wall of the cap formation, to close the outlet orifice when the cap formation is in the first position.

A handle formation may extend radially from the body member. Alternatively the container may be used as a handle for manipulating the applicator.

### BRIEF DESCRIPTION OF DRAWINGS

The invention is now described, by way of example only, with reference to the accompanying drawings, in which:—

FIG. 1 shows a perspective view of an applicator in accordance with the present invention;

FIG. 2 shows a front elevation of the applicator illustrated in FIG. 1;

FIG. 3 shows a side elevation of the applicator illustrated in FIG. 1;

FIG. 4 shows an end elevation, from above, of the applicator illustrated in FIG. 1;

FIG. 5 shows a partial perspective view if the applicator illustrated in FIG. 1, with the cap formation removed;

FIG. 6 shows a cross section of the applicator illustrated in FIG. 1, with the outlet orifice in an open position; and

FIG. 7 shows a cross section of the applicator illustrated in FIG. 1, with the outlet orifice in an closed position.

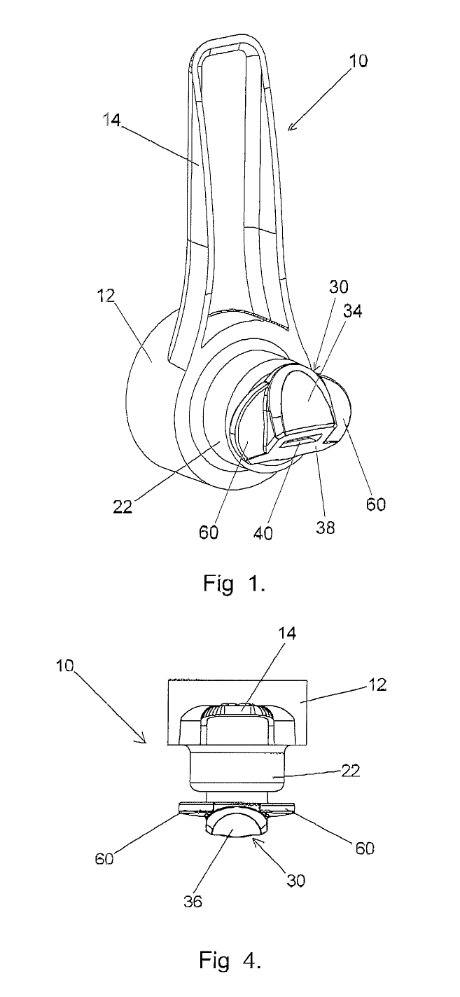

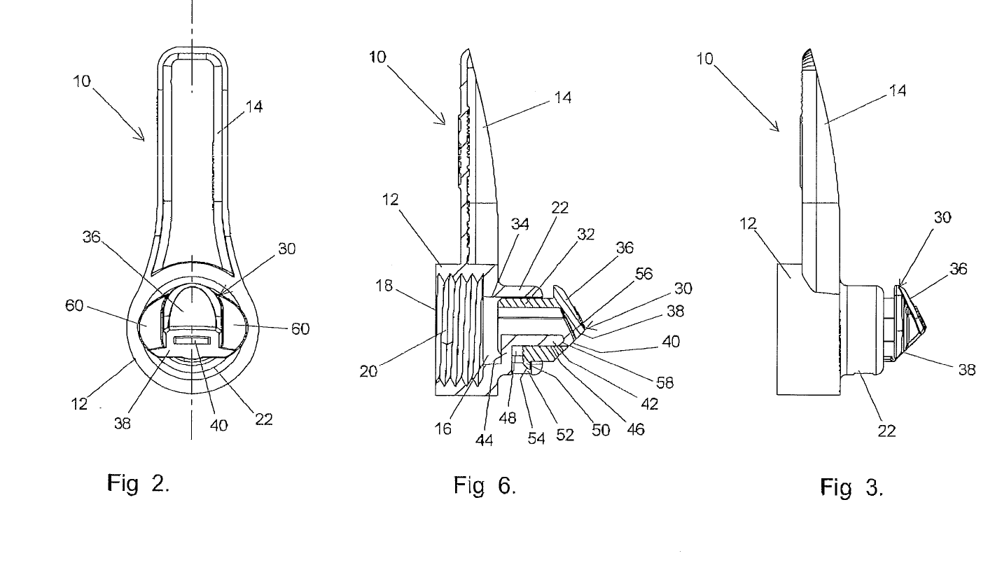

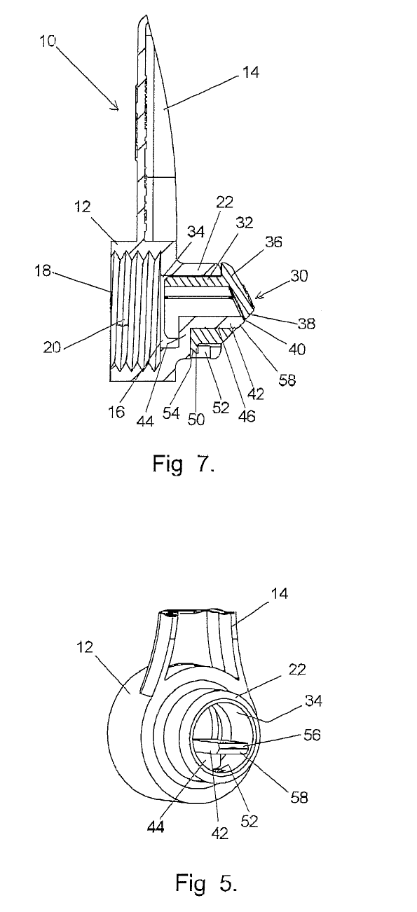

### DETAILED DESCRIPTION OF INVENTION

As illustrated in the accompanying drawings, an applicator 10 comprises a cylindrical body member 12, having a handle formation 14 extending radially from the outer periphery thereof. The body member 12 has a stepped bore 16. The larger diameter end 18 of bore 16 has a screw thread 20, for engagement of a corresponding thread on the neck of a tube containing wax or similar extrudable material.

The external diameter of the body member 12, remote from the threaded end 18 of bore 16, is of reduced diameter to provide a boss formation 22.

A cap formation 30 has a cylindrical wall 32 which is a sliding fit within the smaller diameter end 34 of bore 16. The cap formation 30 has an end wall 36 which extends in a plane inclined to the plane normal to the axis of the cylindrical wall 32. Adjacent the apex of the cap formation 30, the cylindrical wall 32 is chamfered to provide a planar surface 38 which is inclined to both the end wall 36 and axis of the cylindrical wall 32 and to produce an elongate outlet orifice 40 which extends parallel to the plane of the end wall 36 at the junction between the end wall 36 and planar surface 38.

A flat baffle formation 42 extends longitudinally of the bore 16 from a radially extending web formation 44 positioned diametrically opposite the handle formation 14 and adjacent the base of the boss formation 22, beyond the smaller diameter open end of the bore 16. The baffle formation is spaced from the inner circumferential wall of the bore 16 by a distance greater than the nominal thickness of the cylindrical wall 32 of the cap formation 30. The cylindrical wall 32 of the cap formation 30 is thickened in the area adjacent the baffle formation 42 an has a flat face 46 which slidingly engages the opposed face of the baffle formation. The cylindrical wall 32 adjacent the baffle formation 42 is also provided with an axially extending notch 48 to provide a clearance for the web formation 44. An outwardly extending lug formation 50 is provide on the circumferential wall 32 of the cap formation 30, adjacent the end of the notch 48, for engagement in an axially extending slot 52 in the circumferential wall of the boss formation 22, in order limit axial movement of the cap formation 30 relative to the boss formation 22 and to prevent the cap formation 30 from being pulled off the boss formation 22. A chamfered leading edge 54 is provided on the lug formation 50 to permit assembly of the cap formation with respect to the boss formation 22.

The baffle formation 42 is of the same width as the outlet orifice 40. The end of the baffle formation 42 has a double bevel, bevel 56 being off the same inclination as the end wall 36 of the cap formation 30 and bevel 58 being of the same inclination as the chamfered planar surface 38. The baffle formation 42 extends such that when the cap formation 30 is pushed to the limit of its extent towards the body member 12, the bevel 56 will engage the end wall 36 of cap formation 30 and bevel 58 will fill the outlet orifice 40, to close the outlet orifice 40. When the cap formation 30 is at the limit of its movement away from the body member 12, the baffle formation will be clear of the outlet orifice 40, so that wax or similar material may be extruded therethrough.

An elliptical flange formation 60 extends radially outwardly from the cylindrical outer periphery of the cap formation 30 adjacent the lowest point of the end wall 36, the flange formation 60 terminating at the chamfered planar surface 38. The flange formation 60 abuts the end of the boss formation 22 to limit movement of the cap formation 30 towards the body member 12 and also provides means for pulling the cap member 30 away from the body member 12 to open the outlet orifice 40.

In use, the applicator is fitted to a tube of wax or similar material. Where necessary the tube of material and applicator are preheated to melt the wax. This may be done using a dedicated heating apparatus, for example as disclosed in WO96/00021 the disclosure of which is incorporated herein by reference thereto. The outlet orifice 40 is then opened by pulling the cap formation 30 away from the body member 12. The applicator 10 is then drawn across the surface of the skin, utilising the handle formation 14, with the planar surface 38 is trailing, while pressure is applied to the tube, so that wax will be extruded from the outlet orifice 40 onto the surface of the skin. After application of the wax is completed, the cap formation 30 is pushed towards the body member 12 to close the outlet orifice 40.

Various modifications may be made without departing from the invention. For example, while in the above embodiment the wax or similar material is provided in a tube, other containers which allow the material to be pressurised, may be used. Moreover means other that screw threads may be used for connecting the applicator to the container.

The applicator may be used for applying materials other than wax, which may or may not require heating before they can be applied.

While in the above embodiment, the outlet orifice 40 is diametrically opposed to the handle formation 14, so that the applicator is drawn across the surface of the skin with the handle formation 14 leading, the positions may be varied to suit different orientations of the handle, for example so that the applicator is drawn across the skin with the handle to the side.

1. An applicator comprising a body member, the body member being adapted at one end for connection to a container of extrudable material, the body member defining an open bore extending from said one end to an opposite end, the opposite end of the body member defining a boss formation, a cap formation slidably engaging the boss formation for movement axially thereof, between a first position and a second position, the cap formation having a cylindrical side wall and an end wall which closes the bore through the body member, the side wall defining an outlet orifice which opens to the bore through the body member laterally of axis of the bore and a formation on the body member extending longitudinally of the bore within the cap formation, for closing the outlet orifice, when the cap formation is in its first position, the outlet orifice being opened by movement of the cap formation to its second position.

2. An applicator according to claim 1 in which the end wall of the cap formation extends in a plane inclined to the plane normal to the axis of the bore, the outlet orifice being located at the apex of the cap formation.

3. An applicator according to claim 2 in which the outlet orifice is defined in a planar outer wall surface of the cap which is inclined to both the end wall and the axis; of the bore.

4. An applicator according to claim 1 in which the cap formation is slidingly located with respect to an internal cylindrical surface of the boss formation.

5. An applicator according to claim 4 in which a baffle formation on the body member extends longitudinally on the inside of the cylindrical wall of the cap formation, the baffle formation blocking the outlet orifice, when the cap formation is in its first position.

6. An applicator according to claim 5 in which the end wall of the cap formation extends in a plane inclined to the plane normal to the axis of the bore, the outlet orifice being located at the apex of the cap formation, the end of the baffle formation having a first bevel, the inclination of the first bevel corresponding to the inclination of the end wall of the cap formation.

7. An applicator according to claim 5 or 6, in which the outlet orifice is defined in a planar outer wall surface of the cap which is inclined to both the end wall and the axis of the bore, the end of the baffle formation having a second bevel, the inclination of the second bevel corresponding to the inclination of the planar face defining the outlet orifice.

8. An applicator according to claim 7, in which when the cap formation is in its first position, the face of the second bevel is coplanar with the outer surface of the planar outer wall surface.

9. An applicator according to claim 1 in which one or more outwardly directed flange formations are provided on the cap formation.

10. An applicator according to claim 1 in which inter-engaging formations are provided on the cap formation and the body member, to limit relative axial movement and define the first and second positions.

11. An applicator according to claim 1 in which a screw thread is provided at said first end of the body member, for engagement of a corresponding screw thread on the container.

12. An applicator according to claim 1 in which a handle formation is provided on the body member.

13. An applicator according to claim 12 in which the handle formation extends radially from the outer periphery of the body member.

14. An applicator according to claim 12 or 13 in which the handle formation is located diametrically opposite the outlet orifice.
